(19) United States
(12) Patent Application Publication
(10) Pub. No.: US 2011/0239867 A1
(43) Pub. Date: Oct. 6, 2011

(54) ADSORBING/DESORBING DEVICE AND ADSORBATE EXCHANGE STATUS MONITORING METHOD

(75) Inventors: Tadahiko MATSUBA, Tokyo (JP); Ryouta DAZAI, Tokyo (JP); Yoshitaka TAKAKURA, Tokyo (JP)

(73) Assignee: YAMATAKE CORPORATION, Tokyo (JP)

(21) Appl. No.: 13/052,347

(22) Filed: Mar. 21, 2011

(30) Foreign Application Priority Data
Mar. 31, 2010 (JP) 2010-081106

(51) Int. Cl. B01D 53/02

(52) U.S. Cl. 96/143

(57) ABSTRACT

A moisture exchange status monitoring device is provided. The moisture exchange status monitoring device is provided with: a temperature difference detecting portion; an evaluating portion; a setting value storing portion; and an evaluation result outputting portion. The temperature difference detecting portion detects a temperature difference Δt in the air on the treating side before and after passing through a desiccant rotor. The evaluating portion receives the temperature difference Δt from the temperature difference detecting portion and compares the temperature difference Δt to a setting value Δtth that is stored in the setting value storing portion, to evaluate the status of moisture adsorption of the moisture from the air on the treating side of the desiccant rotor. The evaluation result outputting portion outputs the evaluation result for the status of moisture adsorption, from the evaluating portion, as the monitoring result for the status of exchange of the moisture of the desiccant rotor. Similarly, on the regenerating side, the temperature difference Δt in the air on the regenerating side before and after passing through the desiccant rotor is detected to enable monitoring of the status of desorption of the moisture.

### CROSS REFERENCE TO RELATED APPLICATIONS

The present application claims priority under 35 U.S.C. §119 to Japanese Patent Application No. 2010-081106, filed Mar. 31, 2010, which is incorporated herein by reference.

### FIELD OF TECHNOLOGY

The present invention relates to an adsorbing/desorbing device that uses adsorbing/desorbing means that are disposed in a flow path of air on a treating side and the flow path of air on a regenerating side, to perform, respectively, adsorption of the adsorbate from the air on the treating side and desorption of the adsorbate to the air on the regenerating side, and relates to an adsorbate exchange status monitoring method for monitoring the status of exchange of the adsorbate by the adsorbing/desorbing means in the adsorbing/desorbing device.

### BACKGROUND OF THE INVENTION

Conventionally, desiccant air conditioner systems that use desiccant rotors have been used as air conditioners for maintaining low humidity levels in refrigerated warehouses, battery factories, and the like (See, for example, Japanese Unexamined Patent Application Publication 2006-308229 and Japanese Unexamined Patent Application Publication 2001-241693).

A desiccant rotor is formed from a disk, structured so that air can pass through in the direction of thickness thereof A solid adsorbent that has, as its main component, a porous inorganic compound, is provided on the surface of the desiccant rotor. As this type of porous inorganic compound, a silica gel, or a solid adsorbent, such as zeolite, or a polymer adsorbing material, which has pore diameters of the between about 0.1 and 20 nm, and which adsorb moisture is used. Additionally, the desiccant rotor is driven by a motor, to rotate around a center axle to perform continuously adsorption of moisture from the air on the treating side and desorption of the moisture into the air on the regenerating side.

### Desiccant Air-Conditioning System

FIG. 8 illustrates schematically a conventional desiccant air-conditioning system that uses a desiccant rotor. In the figure: 1 is a treating-side fan that produces an airflow on the treating side; 2 is a regenerating-side fan the produces an airflow on the regenerating side; 3 is a desiccant rotor (adsorbing/desorbing means) disposed bridging between a flow path L1 for the air on the treating side and a flow path L2 for the air on the regenerating side; 4 is a cold water coil (cooling device) for cooling air that has been dried on the treating side, after adsorption of moisture by the desiccant rotor 3; 5 is a hot water coil (heating device) for heating the air prior to desorption of the moisture by the desiccant rotor 3; 6 is a motor for driving the desiccant rotor 3 rotationally; 7 is a temperature sensor for measuring the temperature of the air (supply air) SA that has been dried on the treating side, cooled by the cold water coil 4; and 8 is a temperature sensor for measuring the temperature of the air (air for regenerating) SR on the regenerating side, heated by the hot water coil 5; wherein a desiccant air conditioner 100 is structured therefrom.

Cold water CW is supplied through a cold water valve 9 to the cold water coil 4 of the desiccant air conditioner 100, and hot water HW is supplied through a hot water valve 10 to the hot water coil 5. Additionally, a controller 11 is provided for the cold water coil 4, with a controller 12 provided for the hot water coil 5. The controller 11 controls the opening of the cold water valve 9 so that a temperature tspv of the supply air SA, measured by the temperature sensor 7, will match a set temperature tssp. The controller 12 controls the opening of the hot water valve 10 so that a temperature trpv of the air for regenerating SR, measured by the temperature sensor 8, will match a set temperature trsp. 200 is a dry room (space subject to air conditioning) that receives a supply of supply air SA from the desiccant air conditioner 100.

### Treating Side

In this desiccant air-conditioning system, return air RA from the dry room 200 is returned to air on the treating side prior to the adsorbing of moisture by the desiccant rotor 3. In this example, the return air RA is mixed with outside air OA to become air on the treating side prior to the moisture adsorption by the desiccant rotor 3. Note that the amount of return air RA from the dry room 200 is a constant amount, and the amount of outside air OA that is mixed with the return air RA is controlled by a room pressure controlling device, not shown, so as to keep the room pressure in the dry room 200 constant.

On the treating side, when the mixed air of the return air RA and the outside air OA passes through the desiccant rotor 3, the moisture that is included within that air is adsorbed (moisture adsorption) onto the solid adsorbent of the desiccant rotor 3. Following this, the mixed air of the return air RA and the outside air OA, after the moisture adsorption by the desiccant rotor 3, that is, the mixed air of the return air RA and the outside air OA after the removal of moisture by the desiccant rotor 3, is cooled by being sent to the cold water coil 4, and then provided to the dry room 200 as supply air SA.

### Regenerating Side

On the other hand, on the regenerating side, outside air OA is drawn in as the air for the regenerating side, and is heated by being sent to the hot water coil 5. Doing so increases the temperature of the outside air OA, thereby reducing the relative humidity. In this case, the outside air OA is heated to a high temperature, in excess of 100° C., The outside air OA of the high temperature, wherein the relative humidity has dropped, is sent as air for regenerating SR to the desiccant rotor 3, to pass through the solid adsorbent of the desiccant rotor 3.

That is, the desiccant rotor 3 rotates, and when the solid adsorbent that has adsorbed the moisture from the mixed air of the return air RA and the outside air OA on the treating side then faces the air for regenerating SR, moisture is desorbed from the solid desorbing agent, accompanying the reduction in the amount of adsorption that is determined by the adsorption isothermal lines that are dependent on the concentration of the contacting air, thus moving the moisture to the air for regenerating SR. The air for regenerating SR, which has adsorbed the moisture from the solid adsorbent is exhausted as exhaust air EA. Additionally, the temperature of the desiccant rotor 3 is increased through the exchange of heat with the air for regenerating SR.

In this way, in the desiccant air-conditioning system, as the desiccant rotor 3 rotates at a constant angular velocity, adsorption of moisture from the mixed air (the air on the treating side) that comprises the return air RA and the outside air OA, and moisture desorption to the air for regenerating SR (the air on the regenerating side) is performed continuously at the desiccant rotor 3, and the supply air (dry air i.e. air with a low dew point temperature) is supplied from the desiccant air conditioner 100 to the dry room 200. Monitoring the Status of Adsorption/Desorption of the Desiccant Rotor (Monitoring the Status of Exchange of Moisture)

Conventionally, in a low dew point temperature domain, methods by which to monitor the status of adsorption/desorption by the desiccant rotor have been methods that use thermography or dew point temperature sensors, and there has also been research into, for example, methods that use theoretical formulas regarding adsorption.

For example, in the methods that use thermography, methods are used that examine, visually, through thermography, or as distribution data, the temperature distributions on the surface on the outlet side of the air on the treating side of the desiccant rotor 3.

In the methods that use dew point sensors, for example, methods are used that perform direct measurements of the dew point temperature (the outlet dew point temperature) of the air on the treating side from the desiccant rotor 3 using, for example, a mirrored-surface dew point temperature sensor or an electrostatic capacitance dew point temperature sensor.

For example, in the methods that use theoretical equations pertaining to adsorption, data such as the absolute humidity in the equilibrium state, the amount of moisture of the adsorbent, airspeeds, and the like, are subjected to numerical analysis using theoretical equations pertaining to adsorption (See, for example, Tsujiguchi and Kodama, “Adsorption/Desorption Behavior of Water Vapor in an Adsorbent Desiccant Rotor,” Japan Society of Refrigerating and Air Conditioning Engineers, Volume 24, No. 3 (2007), Pages 205 through 216).

Note that systems wherein air is passed through adsorbents are also used as air conditioners for deodorizing and for controlling components. In such systems, the adsorbates are gas components other than moisture, and adsorption/desorption are performed for these gas components. In such cases, there are also methods wherein, the adsorption/desorption is performed in a stationary state, rather than rotating the adsorbent, such as in the desiccant rotor. A component analyzer is used in order to understand the status of adsorption/desorption of the gas components.

However, in the methods for monitoring the status of adsorption by the desiccant rotor that have been researched in the past, in those methods that use thermography or dew point temperature sensors, the thermographic and dew point temperature sensors are expensive, and thus typically thermographic or dew point temperature sensors are not permanently installed, but rather usually they are installed only temporarily. In such a case, because the thermographic or dew point temperature sensors are not permanently installed, it is not possible to understand the status of adsorption/desorption of the desiccant rotor continuously.

Additionally, when an electrostatic capacitance dew point temperature sensor is used as the dew point temperature sensor, there is the need to perform regeneration after exposure for an extended period of time. Because of this, even if the electrostatic capacitance dew point temperature sensor is installed permanently, still it is necessary to interrupt the measurements to perform the regeneration, making it impossible to monitor the status of adsorption/desorption of the desiccant rotor continuously.

In the method that uses the theoretical equations pertaining to adsorption, it is necessary to consider a large number of parameters such as the absolute humidities in the equilibrium state, the amount of moisture of the adsorbent, the airspeed, and the like, and these all must be measured or inferred, which is a tremendous amount of overhead, making it impossible to monitor easily the status of adsorption/desorption of the desiccant rotor.

The same problems occur also in the case of monitoring the status of adsorption/desorption for adsorbing/desorbing means that perform adsorption/desorption of gas components, rather than just desiccant rotors that perform adsorption/desorption of moisture.

The present invention was created in order to solve such a problem areas, and the object thereof is to provide an adsorbing/desorbing device, and an adsorbate exchange status monitoring method, wherein it is possible to monitor easily and continuously the status of adsorption/desorption in adsorbing/desorbing means that perform adsorption and desorption of the adsorbate.

### SUMMARY OF THE INVENTION

In order to achieve the object set forth above, the adsorbing/desorbing device according to the present invention includes adsorbing/desorbing means, disposed in a flow path for air on a treating side and a flow path for air on a regenerating side, for performing, respectively, adsorption of an adsorbate from the air on the treating side and desorption of the adsorbate to the air on the regenerating side; temperature difference detecting means for detecting a temperature difference between the air before and after passing through the adsorbing/desorbing means; and adsorbate exchange status monitoring means for monitoring the status of exchange of the adsorbate by the adsorbing/desorbing means, based on the temperature difference detected by the temperature difference detecting means. Note that the present invention can be embodied as an adsorbate exchange status monitoring method for monitoring the status of exchange of the adsorbate by adsorbing/desorbing means, rather than as an adsorbing/desorbing device.

As one form of the present invention, the detection of a temperature difference in the air on the treating side before and after passing through the adsorbing/desorbing means may be considered as the temperature difference of the air before and after passing through the adsorbing/desorbing means. In this case, the status of adsorption of the adsorbate from the air on the treating side by the adsorbing/desorbing means is monitored based on the temperature difference of the air on the treating side before and after passing through the adsorbing/desorbing means.

Additionally, as one form of the present invention, the detection of a temperature difference in the air on the regenerating side before and after passing through the adsorbing/desorbing means may be considered as the temperature difference of the air before and after passing through the adsorbing/desorbing means. In this case, the status of desorption of the adsorbate to the air on the regenerating side by the adsorbing/desorbing means is monitored based on the temperature difference of the air on the regenerating side before and after passing through the adsorbing/desorbing means.

Additionally, white in the present invention the status of exchange of the adsorbate by the adsorbing/desorbing means is monitored, the adsorbing/desorbing means may be controlled based on the status of exchange of the adsorbate by the adsorbing/desorbing means during monitoring. For example, the status of exchange of the adsorbate from the air on the treating side by the adsorbing/desorbing means may be monitored and the amount of movement of the adsorbing/desorbing means, and the like, may be controlled so that the status of adsorption of the adsorbate will be within a specific range, or the status of desorption of the adsorbate into the air on the regenerating side by the adsorbing/desorbing means may be monitored and the amount of movement of the adsorbing/desorbing means, or the like, may be controlled so that the status of desorption of the adsorbate will be within a specific range.

In the present invention, a temperature difference of the air before and after passing through the adsorbing/desorbing means is detected and the status of exchange of the adsorbate by the adsorbing/desorbing means is monitored based on the detected temperature difference, thus making it possible to monitor the status of adsorption of the adsorbate from the air on the treating side of the adsorbing/desorbing means based on the temperature difference in the air on the treating side before and after passing through the adsorbing/desorbing means, or to monitor the status of desorption of the adsorbate into the air on the regenerating side of the adsorbing/desorbing means based on the temperature difference of the air on the regenerating side before and after passing through the adsorbing/desorbing means, to monitor easily and continuously the status of adsorption/desorption of the adsorbing/desorbing means.

### BRIEF DESCRIPTION OF THE DRAWINGS

FIG. 1 is a diagram illustrating schematically a desiccant air-conditioning system of an adsorbing/desorbing device according to the present invention.

FIG. 2 is a flowchart for explaining the distinctive operations in a moisture exchange status monitoring device in the desiccant air-conditioning system.

FIG. 3 is a diagram illustrating schematically another example of a desiccant air-conditioning system of an adsorbing/desorbing device according to the present invention.

FIG. 4 is a flowchart for explaining the distinctive operations in a moisture exchange status monitoring device in the desiccant air-conditioning system.

FIG. 5 is a diagram illustrating schematically a further example of a desiccant air-conditioning system of an adsorbing/desorbing device according to the present invention.

FIG. 6 is a diagram illustrating schematically yet another example of a desiccant air-conditioning system of an adsorbing/desorbing device according to the present invention.

FIG. 7 is a diagram illustrating an example wherein air on the treating side, wherein the moisture has been adsorbed by the desiccant, is returned to the desiccant rotor as air on the regenerating side.

FIG. 8 is a diagram illustrating schematically a conventional desiccant air-conditioning system.

### DETAILED DESCRIPTION OF THE INVENTION

Examples of the present invention are explained below in detail, based on the drawings.

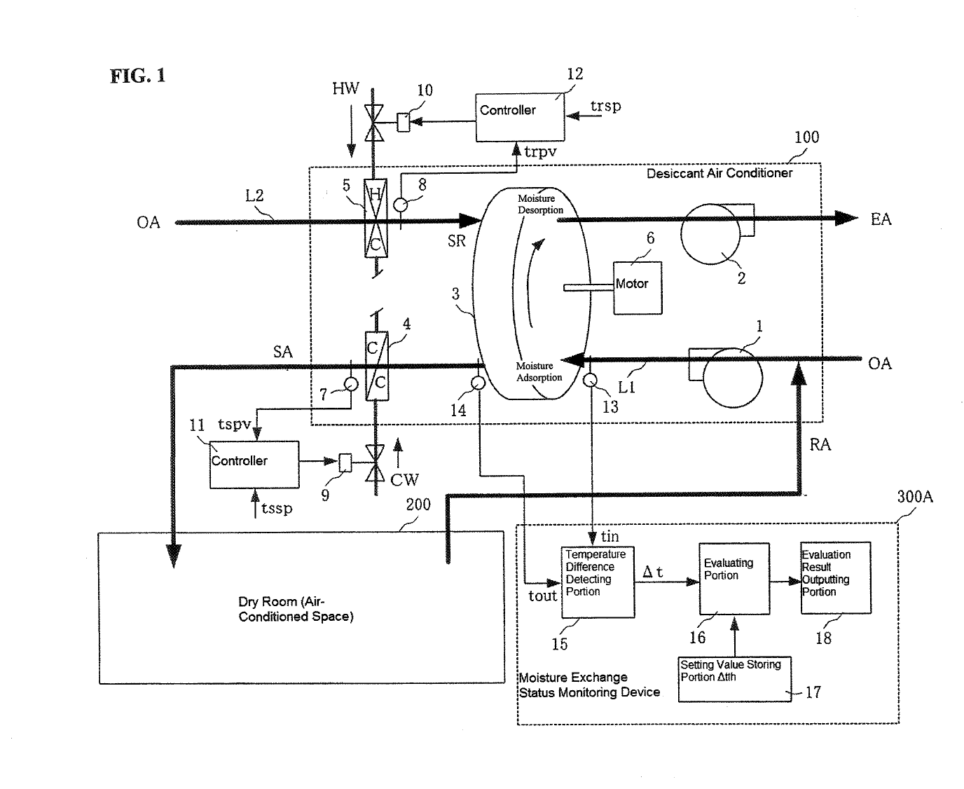

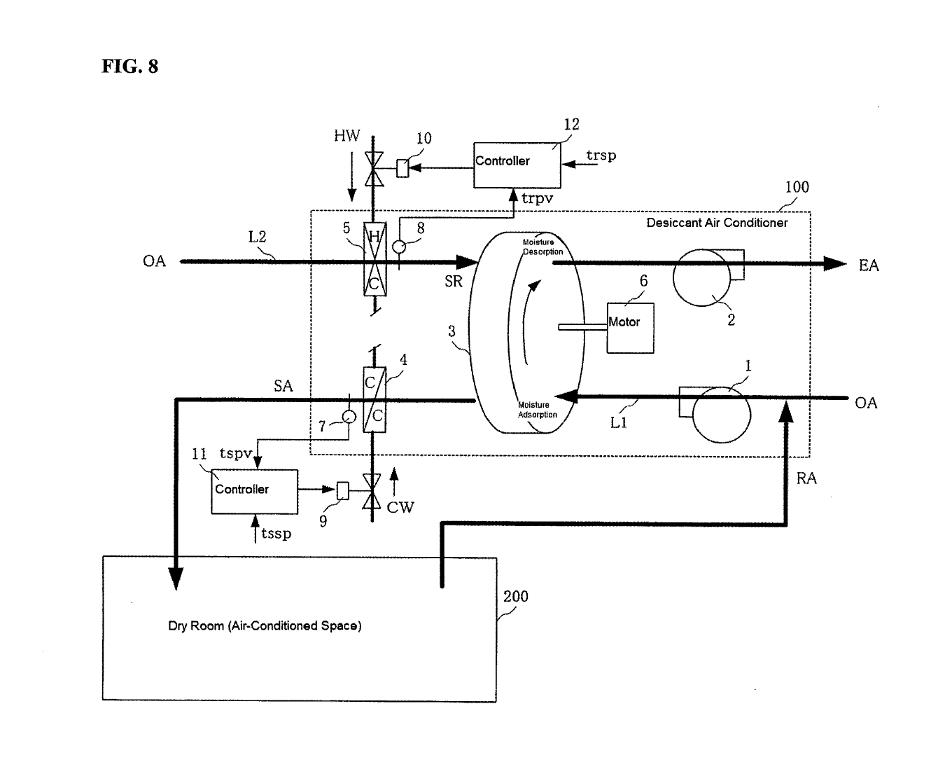

FIG. 1 is a diagram illustrating schematically a desiccant air-conditioning system that includes an example of an adsorbing/desorbing device according to the present invention. In this figure, codes that are identical to those in FIG. 8 indicate structural elements that are identical or equivalent to the structural elements explained in reference to FIG. 8, and explanations thereof are omitted.

In this example, a moisture exchange status monitoring device 300A for monitoring the status of exchange of the moisture of a desiccant rotor 3 in a desiccant air conditioner 100 is provided for the desiccant air conditioner 100, and an adsorbing/desorbing device is structured by the desiccant air conditioner 100 and the moisture exchange status monitoring device 300A.

In this adsorbing/desorbing device, the moisture exchange status monitoring device 300A is embodied through hardware, comprising a processor and a storage device, together with a program for achieving a variety of functions as a monitoring device in cooperation with the hardware, where the status of adsorption of moisture from the air on the treating side of the desiccant rotor 3 is monitored as the status of exchange of the moisture of the desiccant rotor 3.

FIG. 1 illustrates the structure of the critical components of a moisture exchange status monitoring device 300A, including an inlet temperature sensor 13 for detecting the inlet temperature tin, of air on the treating side, into the desiccant rotor 3; an outlet temperature sensor 14 for detecting the outlet temperature tout of the air, on the treating side from the desiccant rotor 3; a temperature difference detecting portion 15 for calculating the temperature difference Δt (where Δt=tin−tout) between the inlet temperature tin of the air on the treating side, detected by the inlet temperature sensor 13, and the outlet temperature tout of the air on the treating side, detected by the outlet temperature sensor 14; an evaluating portion 16 for evaluating the status of moisture adsorption by comparing this temperature difference Δt, from the temperature difference detecting portion 15 to a setting value that has been established in advance; a setting value storing portion 17 for storing at least one setting value (which, in the present example, is the single setting value Δtth) as a standard for evaluating in the evaluating portion 16; and an evaluation result outputting portion 18 for outputting, as the monitoring result for the status of exchange of the moisture of the desiccant rotor 3, the evaluation result calculated by the evaluating portion 16.

Note that the inlet temperature sensor 13 and the outlet temperature sensor 14 are disposed at positions selected by focusing on positions wherein the temperature difference in the air between the measurement locations and the desiccant rotor 3 are stable and relatively small, that is, where the effect due to the exchange of sensible heat due to the temperature difference between the air at the measurement locations and the desiccant rotor 3 can be ignored.

In this desiccant air conditioner 100, the air on the treating side that passes through the desiccant rotor 3 experiences an increase in temperature in accordance with the amount of adsorption, through the production of the heat of adsorption. If the amount of moisture adsorbed (the amount of adsorption) is high, then the change in temperature of the air on the treating side, which is that passes through the desiccant rotor 3, is large due to the increase in the temperature rise due to the heat produced through adsorption, and if the amount of moisture adsorbed (the amount of adsorption) is small, then the change in temperature is small. That is, there is a correlation between the magnitude of the change in temperature in the air and the magnitude of the amount of adsorption of the moisture within the air, at the time of the passage of the air on the treating side through the desiccant rotor 3.

In this example, the status of the moisture adsorption of the moisture from the air on the treating side of the desiccant rotor 3 is evaluated from: (1) the correlation between the magnitude of the change in temperature of the air on the treating side that passes through the desiccant rotor 3 and the amount of moisture absorbed from the air, and (2) a comparison the temperature difference Δt of the air on the treating side that passes through the desiccant rotor 3 to the setting value Δtth that corresponds to the amount of adsorption per unit flow rate, which is stored in the setting value storing portion 17, focusing on the ability to ignore the effect of the exchange of the sensible heat due to the temperature difference between the desiccant rotor 3 and the air at the measurement locations, given the selection of the locations for the provision of the inlet temperature sensor 13 and the outlet temperature sensor 14.

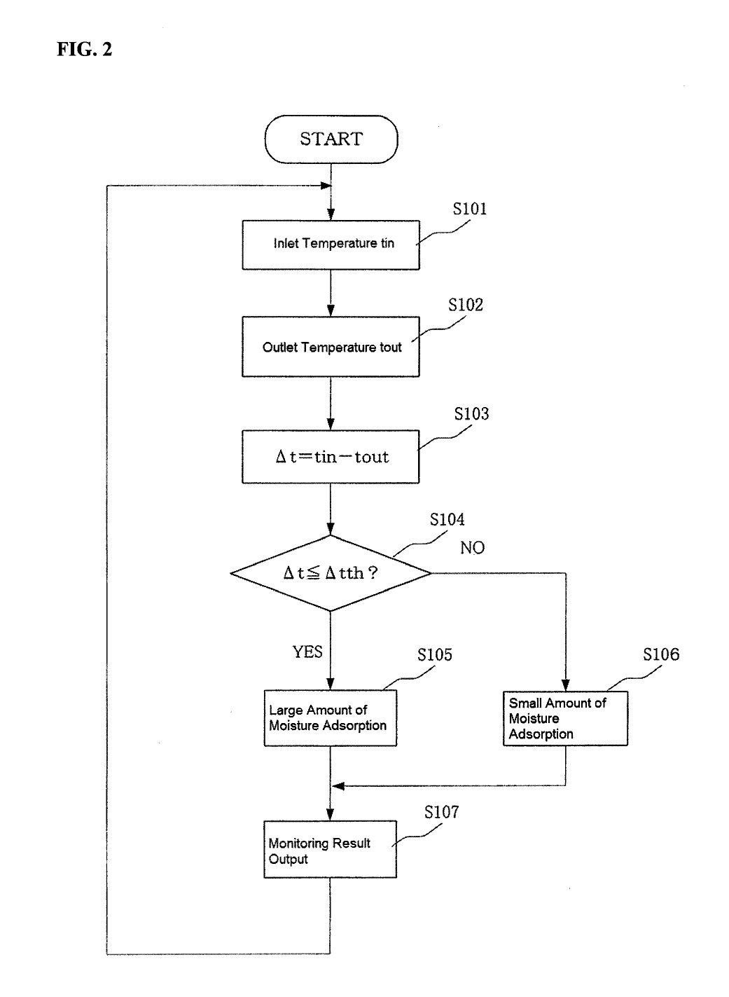

In this moisture exchange status monitoring device 300A, the temperature difference detecting portion 15 corresponds to the temperature difference detecting means in the present invention, and the evaluating portion 16, the setting value storing portion 17, and the evaluation result outputting portion 18 correspond to the adsorbate exchange status monitoring means. In the below, the operations that are the distinctive features in the moisture exchange status monitoring device 300A are explained following the flow chart illustrated in FIG. 2.

The temperature difference detecting portion 15 reads in, at regular intervals, the inlet temperature tin of the air on the treating side to the desiccant rotor 3, detected by the inlet temperature sensor 13, and the outlet temperature tout of the air on the treating side from the desiccant rotor 3 (Step S101 and S102), and calculates the temperature difference Δt between the inlet temperature tin and the outlet temperature tout of the air on the treating side (Δt=tin−tout) (Step S103). This temperature difference Δt, calculated by the temperature difference detecting portion 15, is sent to the evaluating portion 16.

The evaluating portion 16 receives the temperature difference Δt from the temperature difference detecting portion 15 and compares the setting value Δtth that is stored in the setting value storing portion 17 to the temperature difference Δt, and if Δt≦Δtth, determines that the quantity of moisture adsorbed is large (Step S105) but if Δt≦Δtth, then it determines that the quantity of moisture adsorbed is small (Step S106), and sends the status of moisture evaluation, thus determines, to the evaluation result outputting portion 18.

The evaluation result outputting portion 18 receives the evaluation result for the moisture adsorption status from the evaluating portion 16, and outputs the evaluation result as the monitoring result for the moisture exchange status of the desiccant rotor 3 (Step S107), For example, another system may be notified of the status of exchange of the moisture content of the desiccant rotor 3, or the status of exchange of the moisture of the desiccant rotor 3 may be displayed in a form wherein it can be used by the user as a monitoring result.

In this way, the status of adsorption of moisture (status of absorption) from the air on the treating side of the desiccant rotor 3 can be monitored easily and continuously through detecting the temperature difference Δt in the air on the treating side before and after passing through the desiccant rotor 3, and comparing the detected temperature difference Δt with the setting value Δtth.

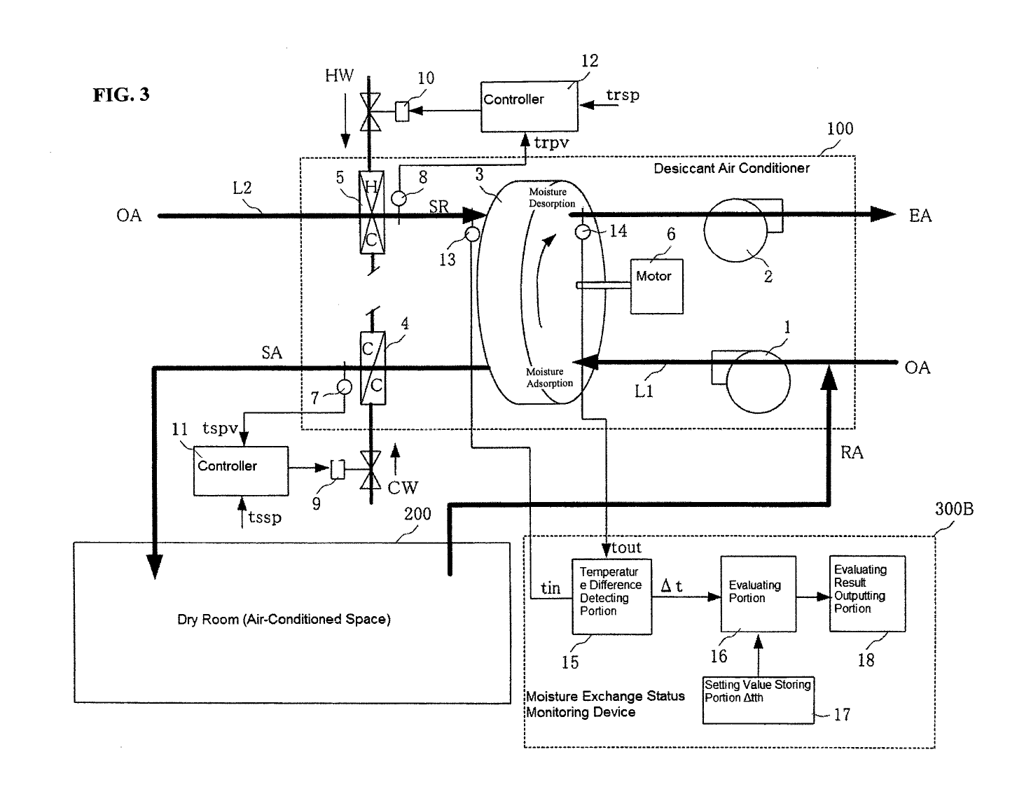

While in the example above the status of moisture adsorption from the air on the treating side of the desiccant rotor 3 was monitored, in this example, the status of moisture desorption into the air on the regenerating side of the desiccant rotor 3 is monitored. FIG. 3 illustrates schematically a desiccant air-conditioning system including an adsorbing/desorbing a device according to the present invention.

In this desiccant air-conditioning system, the inlet temperature tin of the air on the regenerating side into the desiccant rotor 3 is detected by the inlet temperature sensor 13, and the outlet temperature tout of the air on the regenerating side from the desiccant rotor 3 is detected by the outlet temperature sensor 14, and the inlet temperature tin of the air on the regenerating side, detected by the inlet temperature sensor 13, and the outlet temperature tout of the air on the regenerating side, detected by the outlet temperature sensor 14, are sent to the temperature difference detecting portion 15 of a moisture content exchange status monitoring device 300B.

Note that the inlet temperature sensor 13 and the outlet temperature sensor 14 are disposed at positions selected by focusing on positions where the effect due to the exchange of sensible heat due to the temperature difference between the air at the measurement locations and the desiccant rotor 3 can be ignored.

In this desiccant air conditioner 100, the air on the regenerating side that passes through the desiccant rotor 3 experiences an decrease in temperature in accordance with the amount of desorption, through the production of the heat of adsorption/desorption. If the amount of moisture desorbed (the amount of desorption) is high, then the change in temperature of the air on the regenerating side, which is that passes through the desiccant rotor 3, is large due to the increase in the temperature drop due to the heat of adsorption/desorption, and if the amount of moisture desorbed (the amount of desorption) is small, then the change in temperature is small. That is, there is a correlation between the magnitude of the change in temperature in the air and the magnitude of the amount of desorption of the moisture into the air, at the time of the passage of the air on the regenerating side through the desiccant rotor 3.

In this example, the status of the moisture desorption of the moisture into the air on the regenerating side of the desiccant rotor 3 is evaluated from: (1) the correlation between the magnitude of the change in temperature of the air on the regenerating side that passes through the desiccant rotor 3 and the amount of moisture desorbed into the air, and (2) a comparison the temperature difference Δt of the air on the regenerating side that passes through the desiccant rotor 3 to the setting value Δtth that corresponds to the amount of desorption per unit flow rate, which is stored in the setting value storing portion 17, focusing on the ability to ignore the effect of the exchange of the sensible heat due to the temperature difference between the desiccant rotor 3 and the air at the measurement locations, given the selection of the locations for the provision of the inlet temperature sensor 13 and the outlet temperature sensor 14.

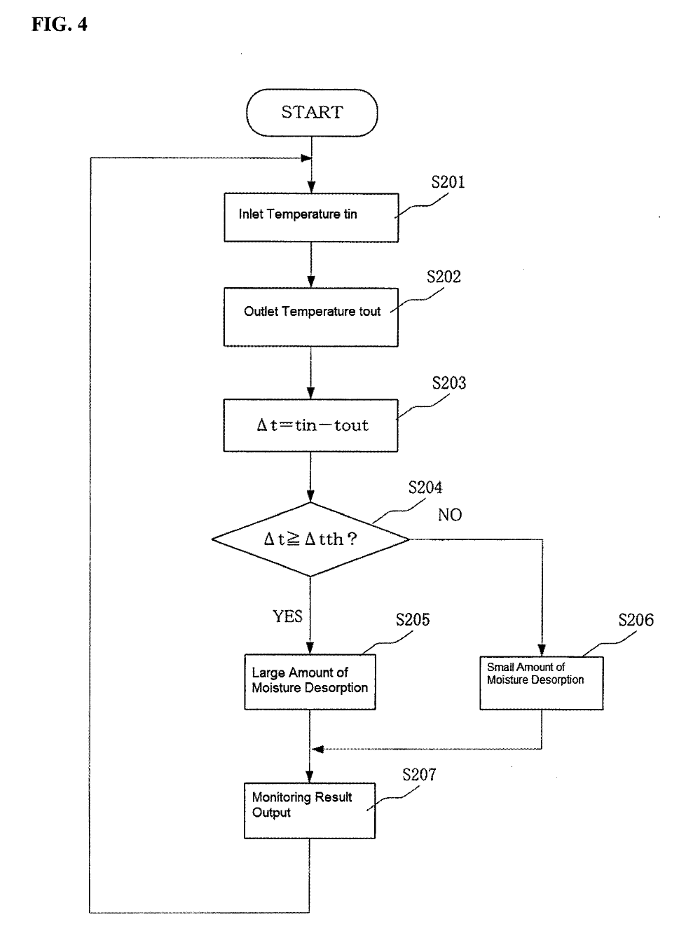

In this moisture exchange status monitoring device 300B, the temperature difference detecting portion 15 corresponds to the temperature difference detecting means in the present invention, and the evaluating portion 16, the setting value storing portion 17, and the evaluation result outputting portion 18 correspond to the adsorbate exchange status monitoring means. In the below, the operations that are the distinctive features in the moisture exchange status monitoring device 300B will be explained following the flow chart illustrated in FIG. 4.

The temperature difference detecting portion 15 reads in, at regular intervals, the inlet temperature tin of the air on the regenerating side to the desiccant rotor 3, detected by the inlet temperature sensor 13, and the outlet temperature tout of the air on the regenerating side from the desiccant rotor 3 (Step S201 and S202), and calculates the temperature difference Δt between the inlet temperature tin and the outlet temperature tout of the air on the regenerating side (Δt=tin−tout) (Step S203). This temperature difference Δt, calculated by the temperature difference detecting portion 15, is sent to the evaluating portion 16.

The evaluating portion 16 receives the temperature difference Δt from the temperature difference detecting portion 15 and compares the setting value Δtth that is stored in the setting value storing portion 17 to the temperature difference Δt, and if Δt>Δtth, determines that the quantity of moisture desorbed is large (Step S205) but if Δt<Δtth, then it determines that the quantity of moisture desorbed is small (Step S206), and sends the status of moisture evaluation, thus determines, to the evaluation result outputting portion 18.

The evaluation result outputting portion 18 receives the evaluation result for the moisture desorption status from the evaluating portion 16, and outputs the evaluation result as the monitoring result for the moisture exchange status of the desiccant rotor 3 (Step S207). For example, another system may be notified of the status of exchange of the moisture content of the desiccant rotor 3, or the status of exchange of the moisture of the desiccant rotor 3 may be displayed in a form wherein it can be used by the user as a monitoring result.

In this way, in this example, the status of desorption of moisture (status of desorption) from the air on the regenerating side of the desiccant rotor 3 can be monitored easily and continuously through detecting the temperature difference Δt in the air on the regenerating side before and after passing through the desiccant rotor 3, and comparing the detected temperature difference Δt with the setting value Δtth.

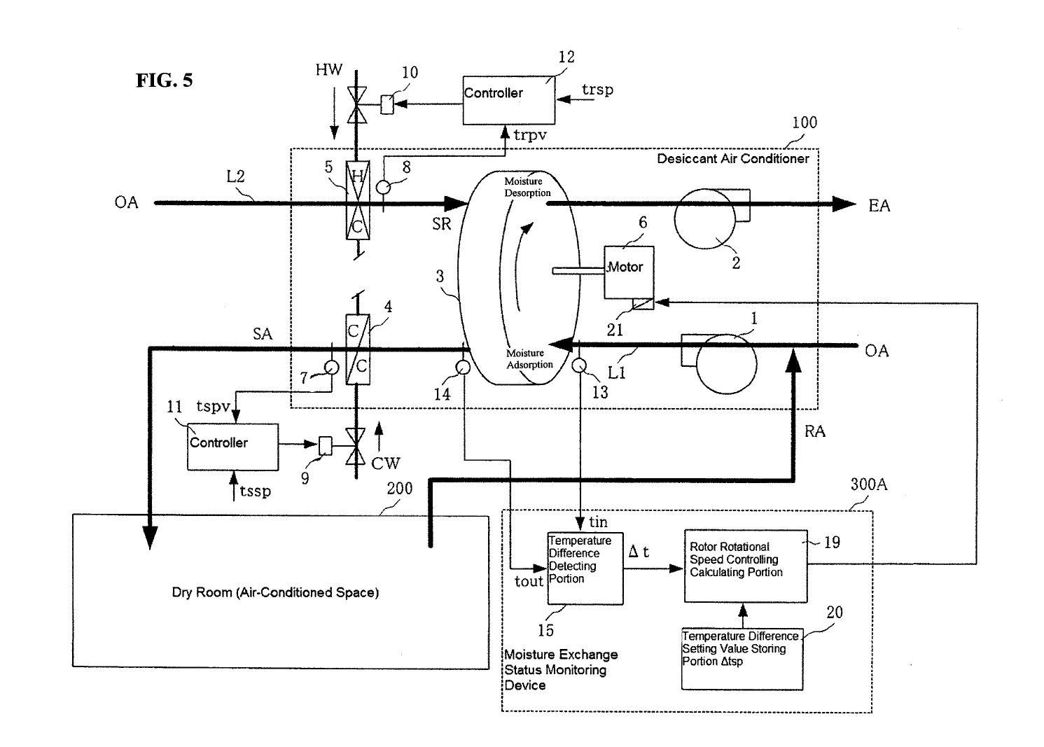

While in the example of FIG. I the status of the exchange of the moisture of the desiccant rotor 3 was outputted as the monitoring result, instead, as illustrated in FIG. 5, a rotor rotational speed controlling calculating portion 19 and a temperature difference setting value storing portion 20 may be provided within the moisture exchange status monitoring device 300A, and an inverter for adjusting the rotational speed may be provided on a motor 6 for driving the desiccant rotor 3, where the temperature difference Δt detected by the temperature difference detecting portion 15 may he sent to the rotor rotational speed controlling calculating portion 19.

In the example illustrated in FIG. 5, the rotor rotational speed controlling calculating portion 19 sends instruction signals (inverter outputs) for the rotational speed to the inverter 21 so as to cause the temperature difference Δt, detected by the temperature difference detecting portion 15, to approach the temperature difference setting value Δtsp that is stored in the temperature difference setting value storing portion 20, to control the speed of rotation of the desiccant rotor 3. Doing so causes the speed of rotation of the desiccant rotor 3 to be adjusted automatically so as to maintain a constant status for the adsorption of moisture from the air on the treating side of the desiccant rotor 3.

In the example of FIG. 3 as well, as with the above example, a rotor rotational speed controlling calculating portion 19 and a temperature difference setting value storing portion 20 may be provided within the moisture exchange status monitoring device 300B, and an inverter for adjusting the rotational speed may be provided on a motor 6 for driving the desiccant rotor 3, where the temperature difference Δt detected by the temperature difference detecting portion 15 may be sent to the rotor rotational speed controlling calculating portion 19.

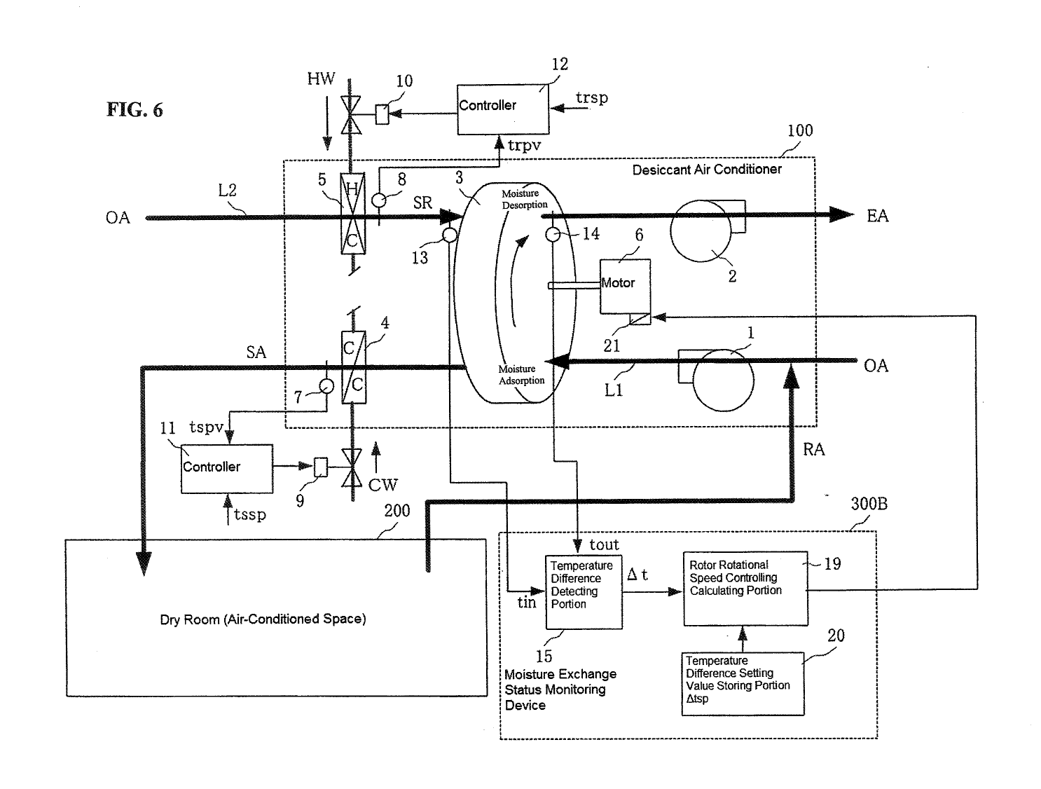

In the example illustrated in FIG. 6, the rotor rotational speed controlling calculating portion 19 sends instruction signals (inverter outputs) for the rotational speed to the inverter 21 so as to cause the temperature difference Δt, detected by the temperature difference detecting portion 15, to approach the temperature difference setting value Δtsp that is stored in the temperature difference setting value storing portion 20, to control the speed of rotation of the desiccant rotor 3. Doing so causes the speed of rotation of the desiccant rotor 3 to be adjusted automatically so as to maintain a constant status for the desorption of moisture to the air on the regenerating side of the desiccant rotor 3.

Note that in the example illustrated in FIG. 5 and FIG. 6, set forth above, a temperature difference threshold value storing portion, for storing, for example, temperature difference threshold values Δtsp1 and Δtsp2 (where Δtsp1<Δtsp2) may be provided instead of the temperature difference setting value storing portion 20, where, in the rotor rotational speed controlling calculating portion 19, a magnitude relationship may be evaluated by comparing the temperature difference Δt, detected by the temperature difference detecting portion 15, and the temperature difference threshold values Δtsp1 and Δtsp2, where the rotational speed of the desiccant rotor 3 may be increased or decreased the so that Δt will go into the range of Δtsp1≦Δt≦Δtsp2.

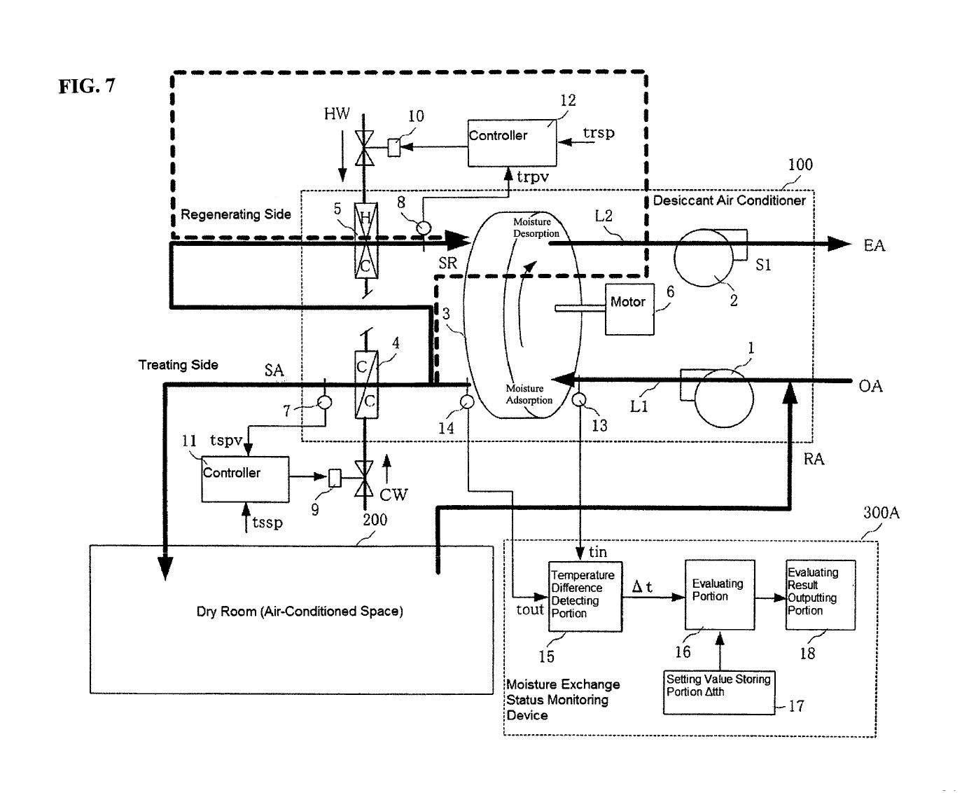

Furthermore, as in FIG. 7, which illustrates a modified form of the example illustrated in FIG. 1, the air on the treating side, from which the moisture has been adsorbed by the desiccant rotor 3, may be returned to the desiccant rotor 3 as air on the regenerating side. In this case, one may consider a variety of systems, such as a system wherein the air on the treating side from which the moisture has been adsorbed by the desiccant rotor 3 is supplied to the desiccant rotor 3 through a hot water coil 5, as indicated by the solid line in FIG. 7, or a case, as indicated by the dotted line in FIG. 7, that is a system wherein a portion of the air on the treating side, from which the moisture has been adsorbed by the desiccant rotor 3, is sent to a portion of the regenerating side of the desiccant rotor 3 that is immediately prior to the transfer to the treating side, and then, after the temperature has been reduced prior to the treating side of the desiccant rotor 3, the air wherein the temperature of the desiccant rotor 3 has been reduced and the air on the treating side wherein the moisture has been adsorbed by the desiccant rotor 3, indicated by the solid line in FIG. 7, is mixed and supplied again to the desiccant rotor 3 through the hot water coil 5.

Additionally, in each of the example set forth above, the treating side fan 1 need not necessarily be provided prior to the desiccant rotor 3 (the inlet side for the air on the treating side), but rather may be provided downstream from the desiccant rotor 3 (the outlet side for the air on the treating side). Similarly, the regenerating side fan 2 need not necessarily be provided after the desiccant rotor 3 (on the outlet side for the air on the regenerating side), but rather may be provided prior to the desiccant rotor 3 (on the inlet side for the air on the regenerating side).

Moreover, while in each example set forth above, the return air RA from the dry room 200 has been returned to air on the treating side prior to the adsorption of moisture by the desiccant rotor 3, outside air OA alone, without the return air RA from the dry room 200, may be provided to the desiccant rotor 3 as air on the treating side.

Additionally, in each of the examples set forth above, the heating device for heating the air on the regenerating side was a hot water coil, and the cooling device for cooling the dry air on the treating side was a cold water coil, there is no limitation of the heating device in the cooling device to being a hot water coil or a cold water coil.

Additionally, while in each of the forms of embodiment set forth above the desiccant air conditioner 100 was of a type that is equipped with a cold water coil 4, it need not necessarily be of the type that is equipped with a cold water coil 4, That is, it may instead be a desiccant air conditioner (outside air conditioner) of a type that sends the air that has been dehumidified by the desiccant rotor 3 to the dry room 200 as supply air SA without cooling. A cold water coil may be placed upstream of the desiccant rotor 3 on the treating side, to cool the air that passes through the desiccant rotor 3. Additionally, a plurality of cold water coils may be provided prior to the desiccant rotor, and a plurality of hot water coils and desiccant rotors 3 may be provided, where, on the treating side, the air may be caused to pass through a cold water coil, a desiccant rotor, a cold water coil, and a desiccant rotor, sequentially, and, on the regenerating side, to pass through a hot water coil, a desiccant rotor, a hot water coil, and a desiccant rotor, sequentially.

Moreover, in each of the examples set forth above, upper and lower limits for the rotational speed of the desiccant rotor 3 may be established, and the rotational speed of the desiccant rotor 3 may be controlled so as to be within the range of the setting values for the upper and lower limits.

Furthermore, while in each of the examples set forth above the explanation was for a case of application to a desiccant air-conditioning system, that is, for a case wherein the adsorbing/desorbing means was a desiccant rotor and the adsorbate was the moisture, the adsorbing/desorbing means are not limited to a desiccant rotor, and the absorbate may be a gas component, or the like. Furthermore, insofar as moisture adsorption/moisture desorption is performed repetitively while moving, the form is not limited to being a rotor. Moreover, the adsorbing/desorbing means need not necessarily involve movement, but may perform adsorption/desorption while remaining stationary.

The adsorbing/desorbing device and the adsorbate exchange status monitoring method according to the present invention can be used in a variety of fields, such as lithium battery factories, foodstuff factories, distribution warehouses, and the like, as an air conditioner for maintaining low humidity.

1. An adsorbing/desorbing device comprising:
an adsorber/desorber, disposed in a flow path for air on a treating side and a flow path for air on a regenerating side, for performing, respectively, adsorption of an adsorbate from the air on the treating side and desorption of the adsorbate to the air on the regenerating side;
a temperature difference detector detecting a temperature difference between the air before and after passing through the adsorber/desorber; and
an adsorbate exchange status monitor monitoring the status of exchange of the adsorbate by the adsorber/desorber, based on the temperature difference detected by the temperature difference detector.

2. The adsorbing/desorbing device as set forth in claim 1, wherein: the adsorbate exchange status monitor controls the adsorber/desorber based on the status of adsorbate exchange.

3. The adsorbing/desorbing device as set forth in claim 1, wherein:
the temperature difference detector detects a temperature difference of air on the treating side before and after passing through the adsorber/desorber, as the temperature difference of the air before and after passing through the adsorber/desorber; and
the adsorbate exchange status monitor monitors the status of adsorption of the adsorbate from the air on the treating side of the adsorber/desorber as the status of exchange of the adsorbate.

4. The adsorbing/desorbing device as set forth in claim 1, wherein:
the temperature difference detector detects a temperature difference of air on the regenerating side before and after passing through the adsorber/desorber, as the temperature difference of the air before and after passing through the adsorber/desorber; and
the adsorbate exchange status monitor monitors the status of desorption of the adsorbate into the air on the regenerating side of the adsorber/desorber as the status of exchange of the adsorbate.

5. An adsorbate exchange status monitoring method for monitoring the status of an exchange of an adsorbate by an adsorber/desorber, disposed in a flow path for air on a treating side and a flow path for air on a regenerating side, for performing, respectively, adsorption of an adsorbate from the air on the treating side and desorption of the adsorbate to the air on the regenerating side, comprising the steps of:
detecting a temperature difference between air before and after passing through the adsorber/desorber; and
monitoring a status of exchange of the adsorbate by the adsorber/desorber, based on the temperature difference detected by the temperature difference detecting step,

6. The adsorbate exchange status monitoring method as set forth in claim 5, wherein:
the adsorbate exchange status monitoring step controls the adsorber/desorber based on the status of adsorbate exchange.

7. The adsorbate exchange status monitoring method as set forth in claim 5, wherein:
the temperature difference detecting step detects a temperature difference of air on the treating side before and after passing through the adsorber/desorber, as the temperature difference of the air before and after passing through the adsorber/desorber; and
the adsorbate exchange status monitoring step monitors the status of adsorption of the adsorbate from the air on the treating side of the adsorber/desorber as the status of exchange of the adsorbate.

8. The adsorbate exchange status monitoring method as set forth in claim 5, wherein:
the temperature difference detecting step detects a temperature difference of air on the regenerating side before and after passing through the adsorber/desorber, as the temperature difference of the air before and after passing through the adsorber/desorber; and
the adsorbate exchange status monitoring step monitors the status of desorption of the adsorbate into the air on the regenerating side of the adsorber/desorber as the status of exchange of the adsorbate.
